(19) United States
(12) Patent Application Publication
(10) Pub. No.: US 2007/0197941 A1
(43) Pub. Date: Aug. 23, 2007

(54) DEK travel massager

(76) Inventor: Dave Koen, Minneapolis, MN (US)

Correspondence Address: Raymond M. Galasso;Galasso & Associates LP, P.O. Box 26503, Austin, TX, 78755-0503, US

(21) Appl. No.: 11/359,220

(22) Filed: Feb. 21, 2006

(51) Int. Cl. A61H 1/00

(52) U.S. Cl. 601/15; 601/49; 601/79

(57) ABSTRACT

The DEK Travel Massager consists of a vest, a plurality of kneading and vibrating modules and heating elements within the vest, and a power source connected to the kneading and vibrating modules and heating elements. The device is worn by an individual over his shoulder, back and neck. The power source located within The DEK Travel Massager provides power to the vibrating and kneading modules and heating elements via insulated wires. A user can customize the heating intensity of the heating elements and the vibration and kneading action of the modules via a remote control. The user can also specify certain modules for vibration or kneading and turn the power off and on using the remote control.

### CROSS REFERENCE TO RELATED APPLICATIONS

This Non-Provisional Patent Application does not claim priority to any United States provisional patent applications or any foreign patent applications.

### FIELD OF THE DISCLOSURE

The disclosures made herein relate generally to health care equipment. The invention discussed herein is in the general classification of therapeutic massage devices.

### BACKGROUND

Many individuals feel stress related to their jobs, family, unfamiliar or difficult situations or a variety of other factors. Unfortunately, stress caused by such everyday occurrences can become a serious detriment to health. High blood pressure, heart attacks and other illnesses can result from prolonged periods of stress. One less serious result of stress may be an individual feeling tightness or discomfort in the neck and/or back region. Many hand held massage devices, creams, chairs and other solutions have been designed to help an individual cope with that tightness or discomfort.

Hand held massage devices are well known in the art but are often uncomfortable to use, requiring the user to manipulate his arm and shoulder to place the vibrating modules of such devices onto the location of his back or neck where he is experiencing discomfort. Also, many of these types of devices require access to an electrical outlet. When such an outlet is unavailable these types of devices are useless.

Some people also use massaging creams to relieve discomfort. However, these creams are often malodorous and difficult to apply. In addition, massaging creams do not provide the vibrating and kneading action that most individuals desire to relieve discomfort or pain in the back or neck region.

Others utilize a massaging chair to provide relief for sore backs or necks. However, these devices are not portable and are often extremely expensive to purchase.

A masseuse is yet another possible solution to relieve sore or tight muscles. Unfortunately such a person is not always readily available and is a luxury most cannot consistently afford.

Hence, there is a need in the art for an easy to use, affordable and portable electronic device for delivering soothing pulsations, heating and kneading action to an individual's back and neck region.

### SUMMARY OF THE DISCLOSURE

The DEK Travel Massager consists of a vest, a plurality of kneading and vibrating modules and heating elements within the vest, and a power source connected to the kneading and vibrating modules and heating elements. The power source permits the modules and heating elements to provide kneading, vibrating, and/or heating action throughout the vest. A remote control will also be used with The DEK Travel Massager to provide ease of use.

The principal object of this invention is to provide an easy to use, electronic massage device.

Another object of this invention is to provide an affordable and portable electronic massage device.

Yet another object of this invention is to provide an electronic massage device capable of providing heat and pulsating and kneading action.

### BRIEF DESCRIPTION OF THE DRAWINGS

FIG. 1 depicts a perspective view of the preferred embodiment of The DEK Travel Massager.

FIG. 2 depicts a perspective view of the preferred embodiment of the modules for use in The DEK Travel Massager.

FIG. 3 depicts a perspective view of the preferred embodiment of the remote control for use with The DEK Travel Massager.

### DETAILED DESCRIPTION OF THE DRAWINGS

The DEK Travel Massager is comprised of at least some of the following: a vest, a plurality of kneading and vibrating modules and heating elements within the vest, and a power source connected to the kneading and vibrating modules and heating elements. Ideally, a remote control will operate The DEK Travel Massager to control levels of pulsation and kneading action and heating intensity.

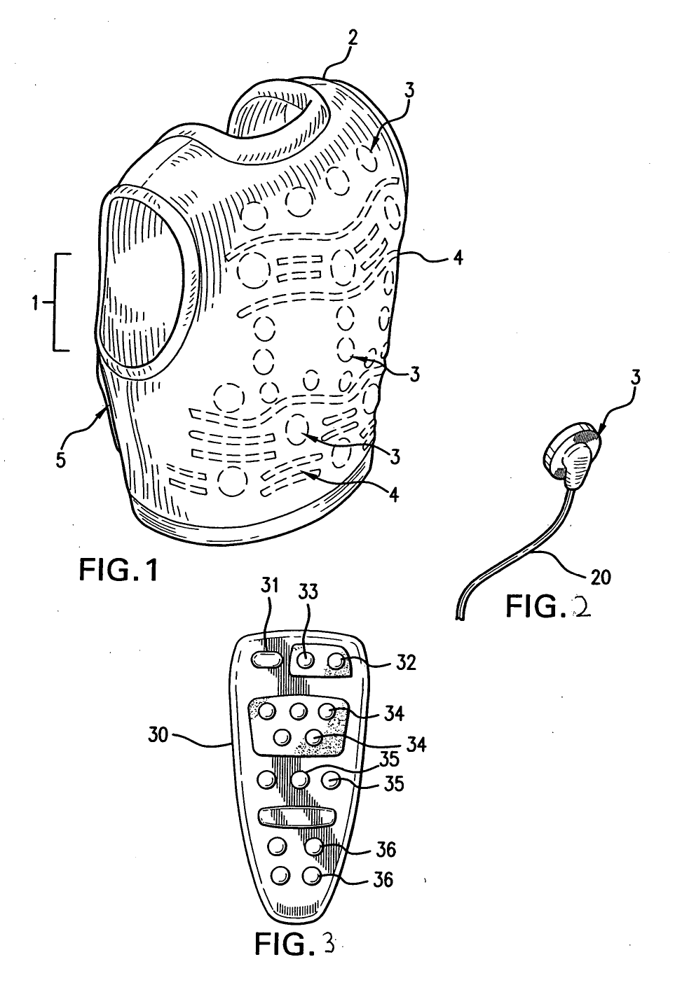

FIG. 1 depicts the preferred embodiment of The DEK Travel Massager 1. It consists of a vest 2 made of cotton fabric. Also, located within the cotton fabric of the vest 2 are a plurality of vibrating and kneading modules 3. A plurality of heating elements 4 are also located within the cotton fabric of the vest 2. Both the plurality of vibrating and kneading modules 3 and the plurality of heating elements 4 are located in the back of the vest 2. A power source (not pictured) is located in a pocket 5 on the side of the vest 2. The power source connects to the vibrating and kneading modules 3 and heating elements 4 via insulated wires (not pictured) also located within the cotton fabric of the vest 2.

The size of The DEK Travel Massager may vary widely. It should be made to accommodate standard small, medium and large sizes for both women and men. The fabric used in making the vest will ideally be made of a lightweight and breathable cotton or other comparable material that is also easy to clean. The vest may also have a variety of closure mechanisms in the front of the vest. Some such closure mechanisms include a button and hole, Velcro hook and loop, or zipper and guide arrangement. In the preferred embodiment of the invention, the interior of the vest also has a lining to protect the user from the electrical components of The DEK Travel Massager.

FIG. 2 depicts the preferred embodiment of the vibrating and kneading module 3. Also depicted is an insulated wire 20 connected on one end to the vibrating and kneading module 3 and on the other end to the power source discussed in FIG. 1.

FIG. 3 depicts the preferred embodiment of the plastic, remote control 30 for use with The DEK Travel Massager. The remote control 30 is approximately rectangular in shape. A power button 31 is located on the front and top of the remote control 30. A high button 32 and low button 33 for controlling the intensity of the heating elements is also located on the front and top of the remote control 30.

A second set of buttons 34, located in the top and middle of the remote control 30, operate specific vibrating and kneading modules within the vest. Yet another group of buttons 35 located in the top and middle of the remote control 30 allow the user to select wave-like, kneading vibrations or pulsating vibrations from the vibrating and kneading modules. Finally, another set of buttons 36 control the speed of the vibrating and kneading modules.

The DEK Travel Massager is worn by an individual over his shoulders, back and neck. The power source located within The DEK Travel Massager provides power to the vibrating and kneading modules and heating elements via insulated wires. A user can customize the heating intensity of the heating elements and the vibration and kneading action of the modules via the remote control. The user can also specify certain modules for pulsating vibration or kneading and turn the power off and on using the remote control.

The components of The DEK Travel Massager may vary widely but will likely utilize metal, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of The DEK Travel Massager can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that any material could be used to make the vest of the present invention. It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A massaging system comprising:
(a) a vest;
(b) a plurality of modules located on the rear of the vest;
(c) a plurality of heating elements located on the rear of the vest; and
(d) a power source located within the vest and connected to the plurality of modules and the plurality of heating elements.

2. The massaging system of claim 1 wherein the vest is made of cotton.

3. The massaging system of claim 1 wherein the vest is made of nylon.

4. The massaging system of claim 1 wherein the plurality of modules can vibrate.

5. The massaging system of claim 1 wherein the plurality of modules can pulsate.

6. The massaging system of claim 1 further comprising
a closure mechanism located on the vest.

7. The massaging system of claim 6 wherein the closure mechanism located on the vest is a hook and hole.

8. The massaging system of claim 6 wherein the closure mechanism is a zipper and guide.

9. The massaging system of claim 6 wherein the closure mechanism is a Velcro hook and loop.

10. The massaging system of claim 1 further comprising
a lining located on the interior of the vest.

11. The massaging system of claim 1 wherein the power source is a battery.

12. The massaging system of claim 11 wherein the battery is rechargeable.

13. The massaging system of claim 1 further comprising
a remote control to operate the plurality of heating elements and the plurality of modules.

14. The massaging system of claim 13 wherein the remote control is approximately rectangular in shape.

15. The massaging system of claim 13 wherein the exterior of the remote control is made of plastic.

16. The massaging system of claim 13 further comprising
a power button located on the remote control.

17. The massaging system of claim 13 further comprising
a plurality of buttons located on the remote control for adjusting the speed of the plurality of modules.

18. The massaging system of claim 13 further comprising
a plurality of buttons located on the remote control for adjusting the plurality of heating elements.

19. The massaging system of claim 13 further comprising
a button located on the remote control for causing the plurality of modules to vibrate.

20. A massaging system comprising:
(a) a cotton vest with an insulated lining on the interior of the cotton vest and a zipper and guide arrangement running the length of the front of the cotton vest;
(b) a plurality of vibrating modules located on the rear of the cotton vest;
(c) a plurality of heating elements located on the rear of the cotton vest;
(d) a rechargeable battery located within the cotton vest and connected to the plurality of vibrating modules and the plurality of heating elements; and
(e) a plastic and approximately rectangular remote control with a plurality of buttons that adjust the plurality of vibrating modules and the plurality of heating elements.
